(19) United States
(12) Patent Application Publication
(10) Pub. No.: US 2009/0182674 A1
(43) Pub. Date: Jul. 16, 2009

(54) FACILITATING FINANCIAL TRANSACTIONS WITH A NETWORK DEVICE

(76) Inventors: Amol Patel, Los Altos, CA (US); Kent Griffin, Mountain View, CA (US)

Correspondence Address: Haynes and Boone, LLP;IP Section, 2323 Victory Avenue, SUITE 700, Dallas, TX, 75219, US

(21) Appl. No.: 12/013,635

(22) Filed: Jan. 14, 2008

(51) Int. Cl. G06Q 40/00

(52) U.S. Cl. 705/72; 705/76; 705/35; 705/39

(57) ABSTRACT

Systems and methods provide for communicating with a user device via a network, receiving a first numeric identifier from the user device, associating the first numeric identifier with a user account, and processing a financial transaction requested by the user device. The user device includes a mobile phone, and the first numeric identifier includes a mobile phone number associated with the user device.

### BACKGROUND

1. Field of the Invention

The present invention generally relates to financial transactions and in particular to facilitating financial transactions over a network using a network-based device.

2. Related Art

A financial transaction services provider may enable a user to initiate a financial transaction between a third-party vendor and a financial services provider (FSP) through applications that are accessible over a network, for example online over the internet. The financial transaction may be a payment for goods or services or a charitable donation or other payment made responsive to an offer or opportunity promoted on an application provided by the third-party vendor and accessible over the network, for example an internet website. The third-party vendor may permit payments to be made by the FSP using financial transaction services provided by the financial transaction services provider. A user may make such a payment if the user has previously established an account with the financial transaction services provider, for example from a computer or device that has a full-feature browser, for example a laptop computer or desktop computer. Information supplied to when creating the account may include alpha-numeric information, including, for example, the user's name and address.

With the increase in mobile and/or handheld network-based devices, there has been an increase in users access third-party vendor's websites using such devices. Such devices may have a small keyboard, small input keys, limited keyboard and/or limited browser features. A user who has previously set up a financial transaction service account from a full-feature browser may initiate purchases and make online payments through their handheld device. However, a user who has not previously set up a financial transaction service account may be required to create a new financial transaction services account. Creating the new account may be inconvenient or cumbersome due to the small, inconvenient keyboard and/or the non-full featured browser. In order to encourage more online purchases from mobile or handheld devices, it is desirable to provide a more efficient or convenient system and method to enable users to initiate a purchase and/or create a new account using a mobile or handheld device such as a mobile phone.

### SUMMARY

Embodiments of the present disclosure relate to facilitating financial transactions over a network using a mobile device by establishing a financial transaction account or by creating a financial transaction record. For example, in one implementation, a user may set up an account from a mobile device without manually entering user information, which may be retrieved from a database. The database may be an electronic phone listing service, a service provided by the local phone company, or some other entity with a database adapted to map user information to phone numbers. The database may be maintained by a mobile device network service provider. For example, when a user obtains or purchases a device, the user may be given the option of sharing their user information with a payment service.

In one embodiment, a user establish an account associated, for example, with a mobile device by pressing an appropriate key or keys on the mobile device. The phone number for the mobile device may be automatically sent to the telephone service provider, or the user may respond to a prompt by entering their device identifier, for example their telephone number. The user may be asked to enter an additional data set, for example the postal code where their billing address is located or a partial street or postal address, for example the street numbers. The additional data set may comprise a PIN for identification purposes. The system may access a database to search for a match for the telephone number. The system may store the user information in a database, which may be mapped to the user's device so that any subsequent purchases from the device may be recognized as being made by the particular user. The user may input billing information, for example, a credit card number, which may be entered and stored in the database for use in future transactions.

In accordance with embodiments of the present disclosure, systems and methods include an interface to communicate with a user device via a network, a first component adapted to receive a first numeric identifier from the user device and associate the first numeric identifier with a user account, and a second component adapted to process a financial transaction requested by the user device.

In various implementations, the user device includes a mobile phone, and the first numeric identifier includes a mobile phone number associated with the user device. The first component may be adapted to receive a second numeric identifier from the user device and compare the second numeric identifier to the first numeric identifier and the user account to verify the identity of the user device prior to processing the requested financial transaction. The second numeric identifier may include a security code, such as a PIN number. A database may be included and adapted to store information related with the user account, wherein the first component is adapted to query the database and retrieve the user account associated with the first numeric identifier. The first component may be adapted to receive a request for the financial transaction from the user device, and the second component may be adapted to process the financial transaction based on information passed with the request. The interface may be adapted to communicate with a third party via the network, and the second component may be adapted to transfer payment from the user account to an account associated with the third party via the network to complete the requested financial transaction.

In accordance with embodiments of the present disclosure, systems and methods include communicating with a user device (e.g., mobile phone) via a network, receiving a first numeric identifier (e.g., mobile phone number) from the user device, associating the first numeric identifier with a user account, and processing a financial transaction requested by the user device.

In various implementations, the systems and method may include receiving a second numeric identifier from the user device and comparing the second numeric identifier to the first numeric identifier and the user account to verify the identity of the user device prior to processing the requested financial transaction, wherein the second numeric identifier may include a security code, such as a PIN number. The systems and methods may include storing information related with the user account in a database and querying the database to retrieve the user account associated with the first numeric identifier. The systems and methods may include receiving a request for the financial transaction from the user device and processing the requested financial transaction may be based on information passed with the request. The systems and methods may include communicating with a third party via the network and completing the requested financial transaction by transferring payment from the user account to an account associated with the third party via the network.

These and other features and advantages of the present invention will be more readily apparent from the detailed description of the embodiments set forth below taken in conjunction with the accompanying drawings.

### BRIEF DESCRIPTION OF THE FIGURES

FIG. 1 shows a network diagram illustrating a system having a client-server architecture according to an embodiment of the present disclosure.

FIG. 2 shows a block diagram illustrating an application server according to an embodiment of the present disclosure.

FIG. 3 shows various tables maintained within one or more databases according to an embodiment of the present disclosure.

FIGS. 4-5B show process flow diagrams of methods for facilitating financial transactions according to various embodiments of the present disclosure.

FIG. 6 is a block diagram of a computer system suitable for implementing embodiments of the present disclosure.

Embodiments of the invention and their advantages are best understood by referring to the detailed description that follows. It should be appreciated that like reference numerals are used to identify like elements illustrated in one or more of the figures, wherein showings therein are for purposes of illustrating embodiments of the invention and not for purposes of limiting the same.

### DETAILED DESCRIPTION

Embodiments of the present disclosure relate to data processing and to initiating financial transactions over a network using a mobile device by establishing a financial transaction services account or by creating a prospective financial transaction record.

Embodiments of the present disclosure relate to using a mobile network device, such as a mobile phone, to create a new account and make a payment. The mobile phone number is associated with a login name and a security code (e.g., 4-digit code) that may be selected at the time of creation of a new account. As such, a new account may be initiated with a mobile phone with the mobile phone number, and a user may add a secure card number (e.g., credit or debit card number) and a security code number (e.g., PIN number) for the new account. In various implementations, the account may be a “Mobile-Only Account” or a full account that is accessible online or in person. In various other implementations, the new account may include a bank account associated with a banking institution, and the bank account may be associated with a secure number. In still other various implementations, one or more balances from one or more other accounts may be linked to at least one secure number so that funds may be transferred between the one or more accounts to resolve financial transactions.

Embodiments of the present disclosure relate to text-to-buy financial transactions, wherein a user may not have linked a particular account to a mobile phone, but may want to perform a text-to-buy transaction. In this instance, the user may text a message to initiate the financial transaction. Within a certain period of time (e.g., 12-24 hours), the user may have access to this financial transaction and complete related credentials at a later time (e.g., either online or on a mobile phone). Once the credentials for the user are complete, the user may receive the purchased item.

Embodiments of the present disclosure relate to a user establishing an account from a mobile device without manually entering user information, which may be drawn from a database. In various implementations, the database may be an electronic phone listing service, a service provided by the local phone company, or some other entity with a database adapted to map user information to phone numbers. In one implementation, the database may be maintained by a mobile device network service provider. When a user first obtains or purchases a device, the user may be given the option of sharing their user information with a payment service. In one example, this arrangement may be contractually established between the payment service and the telephone service provider and provided as a convenience for users.

In one embodiment, a user may establish an account associated with a mobile device by pressing an appropriate key or keys on the mobile device. The phone number for the mobile device may be automatically sent to the telephone service provider, or the user may respond to a prompt by entering their device identifier, for example their telephone number. The user may be asked to enter an additional data set, for example the postal code where their billing address is located or a partial street or postal address, for example the street numbers. In one implementation, the additional data set may include a PIN for identification purposes. The system may access the external database to search for a match for the telephone number. The system may display the user information retrieved on the user's screen and ask the user to verify by simply pressing a single keystroke to indicate yes or no, for example pressing the “y” or “n” or “1” or “0” as determined by the system programming. The system may store the user information in a database, which may be mapped to the user's device so that any subsequent purchases from the device may be recognized as being made by the particular user. The user may input billing information, for example a credit card number. The credit card number may be entered during an initial set-up session and the information stored in the database for use in future transactions. Further scope and functionality of these features is described in greater detail herein.

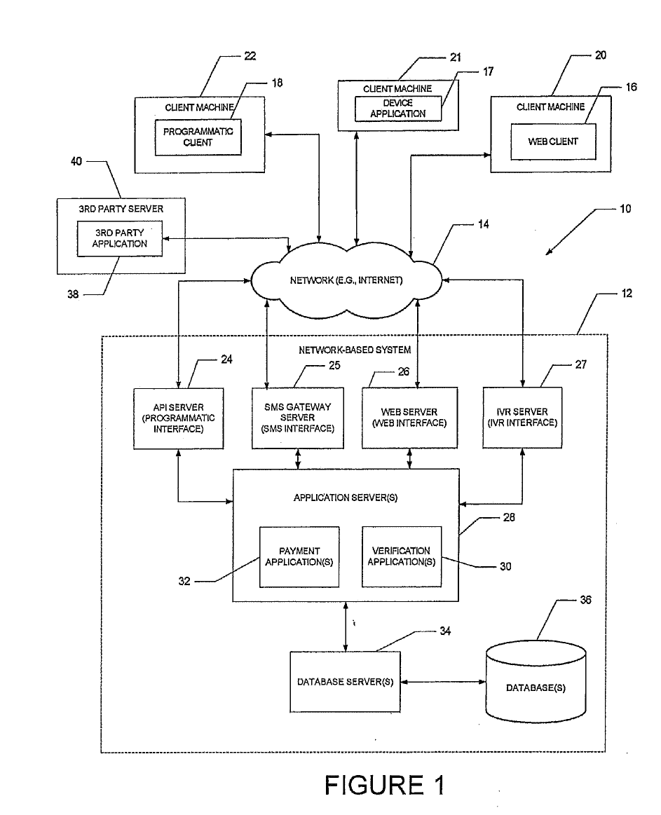

FIG. 1 shows one embodiment of a network diagram depicting a system 10. In various implementations, the system 10 may be a network-based system 12 that provides server-side functionality via a network 14 (e.g., the Internet, a public or private telephone network that is either wired or wireless), a private wireless network using technologies (e.g., Blue-tooth or IEEE 802.11x or other networks) to one or more clients.

As shown in FIG. 1, the system 10 includes a web client 16 (e.g., an Internet browser) and a programmatic client 18 executing on respective client machines 20, 22 (e.g. on a network-based device). A device application 17 may execute on a client machine 21. While the system 10 shown in FIG. 1 employs a client-server architecture, embodiments are of course not limited to such an architecture, and could equally well find applications in a distributed, or peer-to-peer, architecture system. In one example, the client machine or device 20, 21, 22 may be a mobile or handheld device (e.g., cell phone, wireless personal digital assistant (PDA)), and may have a keyboard component and/or a some type of functional web browser component. A user may use the device 20, 21, 22 to contact a third-party vendor server 40 via network 14. The user may initiate a financial transaction by using a network-based system 12 (e.g., a financial transaction services system) via network 14. The user may initiate the financial transaction by establishing a new account or by creating a prospective financial transaction record with the financial services provider system 12.

In various embodiments, the client machines including network-based device(s) 20, 21, 22 may comprise a mobile device (e.g., cell phone), a palmtop computer, a laptop computer, a desktop computer, a personal digital assistant, a cellular telephone, a communications device, a wireless telephone, a telephone with a web browser, and/or a personal trusted device. The device 20, 21, 22 may include a card, such as a smart card, a magnetic card, and/or a key card. The device may include a telephone or any device capable of Short Messaging Service (SMS) messaging, multimedia messaging service (MMS) messaging and/or generating audio tones, such as dual-tone multi-frequency (DTMF) tones. The device may be browser-enabled. The device may engage in an interactive message and/or open communication session, such as SMS, electronic mail, xHTML, Wireless Application Protocol (WAP), web, interactive voice response (IVR) and/or other mobile interfaces. The interactive messaging or open communication session may involve multiple technology modalities, e.g. the client user may engage the system via SMS and receive a responsive communication from the IVR Server or as an SMS with an embedded hyperlinked URL directing the client user's device to a WAP or web page. A hyperlinked URL may be delivered directly to the device from the application server(s) 28 and may be used to access a website or a micro-browser, such as a WAP site. The device 20, 21, 22 may enable mobile videophone communications, digital television signals, and/or digital radio signals.

A third-party party vendor application, in one embodiment, may be connected to the network and may run on a third party server. The third party application may, for example, provide one or more promotional, marketplace or payment functions that are supported relevant applications of the network-based system 12. For example, the third party website may offer goods or services for sale at a stated price or may offer the opportunity to donate money for any purpose, for example a charitable contribution. The third-party vendor application may have access to the network-based system for the purposes of providing a means of providing financial transaction services related to the offer, for example providing a means of effecting payment for the goods or services advertised or promoted by the third party application. In one implementation, the third party may comprise a merchant, and the third party server 40 may comprise a merchant server that is accessible via the network 14.

A third-party database 39, in one embodiment, may be connected to the network for communication therewith. The third-party database 39 may include a database mapping unique numeric data to unique non-numeric data, for example alphabetic characters. The numeric data may be a telephone number, for example the telephone number of the device 20, 21, 22 itself, or partial physical address numbers, for example street address numbers and postal code, or personal ID number (for example social security number). In one implementation, the data may be any data included in any database, provided that there is a unique numeric number(s) that are mapped to unique non-numeric identifiers, for example name and address. In another implementation, the database may be a publicly available telephone listing or other public record with numeric data mapped to non-numeric data.

A network service provider, in one embodiment, may collect personal data when a user first associates their device with the network services. For example, a mobile telephone service provider may collect name and address and associate the name and address to the telephone or device from which the user will access a network. The users may be given the option of being able to establish a financial transaction services account in the future and may have the option of giving permission to the financial services provider to access their information for the purpose of establishing an account. In other embodiments, the entity that collects the information may share the information with the financial services provider before the account is established, in which case the third-party database 39 may be included within the system 12.

Referring to the network-based system 12, an Application Program Interface (API) server 24, a Short Messaging Service (SMS) Gateway Server 25, a web server 26, and an Interactive Voice Response (IVR) server 27 may be coupled to, and may provide programmatic, SMS, web, and IVR interfaces, respectively to, one or more application servers 28. In various implementations, the devices may use one or more of these interfaces to access the application server(s) 28.

In one implementation, the web client 16 may be adapted to access the application server(s) 28 via the web interface supported by the web server 26. The web interface may include a web browser or any micro-browser, such as xHTML or WAP. Similarly, the programmatic client 18 accesses the various services and functions provided by the application server(s) 28, via the programmatic interface provided by the API server 24 and/or the web server 26. In an additional embodiment, an application supported by one or more applications of the application server(s) may be downloadable to the network-based device. The device(s) may host the interface associated with the one or more applications of the application server(s) 28. The interface on the device may be an API interface, an SMS interface, a web interface, and/or an IVR interface. Consumer wireless device platforms, such as Java 2 Platform Micro Edition (J2ME), J2SE and J2EE allow developers to use Java and a wireless toolkit to create applications and programs for the device 22. The J2ME interface may include an application programming interface (API) for the device. The application of the programmatic client may also access the Internet using, for example, Binary Runtime Environment for Wireless (BREW).

In one embodiment, the device application 17 executed on the client machine 21 may access the application server(s) 28 via the web interface of the web server. The application 17 may be selected on the device and the Internet may be launched in a background. The application 17 may additionally or alternatively access the server(s) 28 via the IVR interface of the IVR server 27, via the SMS interface of the SMS Gateway server 25, and/or via the programmatic interface of the API server 24. In one aspect, the downloaded application described herein may include the device application 17.

The application server(s) 28, in one embodiment, may host one or more verification application(s) 30, one or more payment application(s) 32, one or more registration application(s) 33, and one or more prospective financial transaction record application(s) 34. As such, the application server(s) 28 are, in turn, shown to be coupled to one or more database servers 35 that facilitate access to one or more databases 36.

In various implementations, the one or more registration application(s) 33 may facilitate a user in initiating a financial transaction by creating a new financial transaction services account with the financial services provider. In one embodiment, a client machine 20 may have accessed a third-party application 38 on a third-party server 40. In one embodiment, a user may have been using the device to shop on a website provided on the third-party server. The third-party application may include a link to access the system 12 for the purposes of accomplishing a financial transaction using the financial transaction services provided by the system 12. In the event that the user does not have a pre-established account stored in the system database(s) 36, the registration application 33 may provide the user with a prompt to create the account.

The prompt, in one embodiment, may request that the user input non-numeric data. As such, the registration application may extract device identifying data from a header embedded in communication packets from the device 20. For example, the application 33 may extract a telephone number from the communication packet. In another embodiment, a user may be prompted to enter their telephone number. The telephone number may be stored in a record and may be used as the account number. In various other embodiments, a user may be prompted to input voice-based data and/or some form of biometric data.

The user, in one embodiment, may be prompted to enter numeric data other than a telephone number, for example a landline phone number, a partial physical address, for example a street number and/or a postal code or zip code. A user may also be prompted to enter a number personal identifying number (PIN) to be used to access the account and verify that the user is authorized to use the account.

The registration application 22, in one embodiment, may connect with a third-party database 39, for example, over the network 14. The third-party database may include numeric data mapped to non-numeric data. If the input numeric data is found in the database 39, the application 33 may retrieve any non-numeric data associated with the numeric data. The application 33 may display the non-numeric information to the user on a screen on the device 20. The user may be prompted to affirm or reject the information.

The information, in one embodiment, from which may be stored in the database(s) for future verification of purchases to facilitate future financial transactions to purchase goods or services from the third-party vendor application. The registration application may access the third-party database for the purpose of extracting non-numerical user identifying information responsive to data, for example numeric information, input by the user from the client device. The third-party database may make it possible to establish a financial transaction service account without requiring a user to enter non-numeric, for example alphabetic characters. The user identifying information, device identifying information and a PIN may be stored in the system database to be accessed by the verification application. Funding source information input by the user during a registration process may be stored in the database to be accessed by the payment application when purchasing a product or service from the third-party vendor website.

The verification application(s) 30, in one embodiment, may provide verification of an order. In one implementation, verification may include analysis of the order, such as from an identifier 166, to ensure that the identifier corresponds with a third party offer in the database(s) 36. Further, verification may include ensuring that the offer, such as a product, a service or a donation opportunity, still exists from the third party. Verification may additionally or alternatively include inventory analysis with respect to the offer, e.g. verifying the product is in stock. The verification application(s) 30 may communicate with a third party application 38 executing on a third party server 40 to determine if the identifier corresponds with the third party offer, to determine if the offer still exists, and/or to determine if the product is in stock, for example.

The verification application(s) 30, in one embodiment, may communicate with the third party application 38 to verify an order. As such, the third party may receive, from the payment application(s) and/or verification application(s), order information, shipment information, and an associated payment and/or payment confirmation. The third party application 38 may receive and process the order, send a virtual receipt to the payment application(s) 32, and forward the order to the client user. For services and/or donations, the third party may receive a requested order and the payment confirmation, exclusive of the user contact information, such as a shipment address. In an additional embodiment, the service provider or charity may receive client user contact information and may send a receipt to the client user.

The third-party database, in one embodiment, may be compiled by an entity not related to the device or the wireless service. For example, the database may be compiled by a telephone company and may map a device's telephone number to a user's physical or mailing address. The third party server may provide the user with a prompt to enter a numerical identifier. When the numerical identifier has been input, the registration application accesses the numerical identifier or identifiers with the third-party database. If the identifying number or numbers exists in the database, the third-party database provides the user identifier to the registration application 33. The registration application 33, in turn, displays the tentative user identifier on the user's screen. The user may be prompted to acknowledge that the displayed tentative user identifier corresponds to the user, whereupon the user may select yes by inputting data from the keypad, for example by pressing “y” for yes or “n” for no, as appropriate. If the user acknowledges that the information applies, the registration application provides the device identifier and the user identifier to the database server(s) to create an entry in the database 36 associating the user with the device.

The user, in one embodiment, may then be prompted to input numerical payment information, for example a credit card number and/or bank account number and a bank routing number, as appropriate. The registration application may prompt a user to select a type of payment, for example, from a drop down menu, and then to input the appropriate number or sets of numbers as appropriate. A user may be prompted to establish a numerical personal identifying number (PIN). In subsequent purchasing transactions, when a user initiates contact with application servers, the payment application and verification application may recognize the device and permit access for conducting a financial transaction.

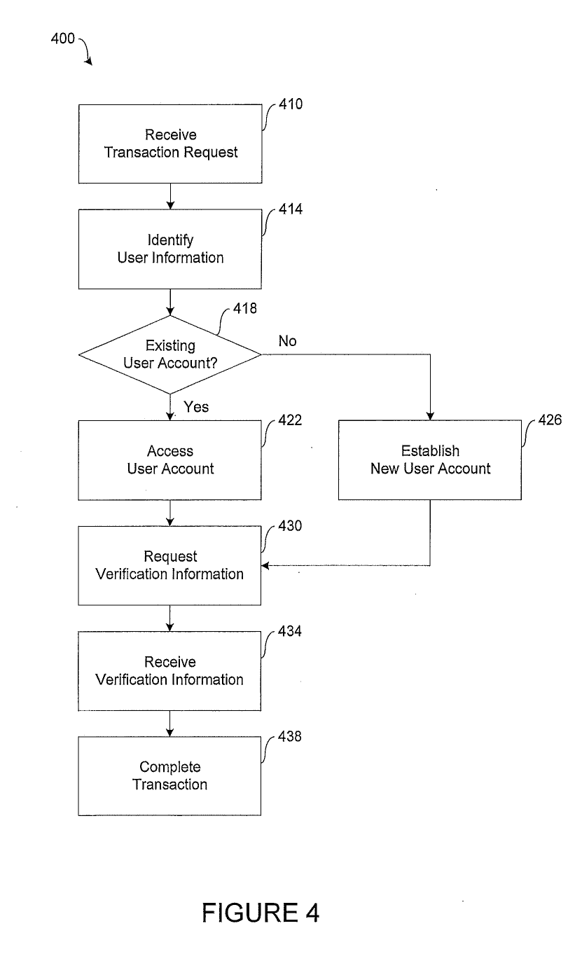

The payment application(s) 32, in one embodiment, may provide a number of payment services and functions to users, such as client users. The payment application(s) 32 may allow users to accumulate value (e.g., in a commercial currency, such as the U.S. dollar, or a proprietary currency, such as “points” and/or “airtime minutes”) in accounts, and then later to redeem the accumulated value for an offer (e.g., goods, services, promotions, or donation opportunities) offered via a listing 164, as shown in FIG. 4. The payment applications, e.g. a financial service provider, may also extend credit to user, and/or may also have access to other funding sources to complete transactions—e.g. a credit card, a bank account, and/or a credit line. The financial service provider may operate as a money transmitter or a bank, for instance, and may operate using the payment application(s) 32.

The third party or vendor, in one embodiment, may receive from the payment application(s) and/or the financial service provider (FSP): information regarding a requested order for a product, a service, or a donation amount (e.g. the identifier), information regarding the shipment address specified by the client user, and the payment confirmation from the financial service provider as specified above. The payment application(s) and/or the financial service provider may secure financial information of the client user with respect to the third party. The FSP may not be sharing the financial information of the client user with the third party. For example, the payment may be received by the third party exclusive of the payment method and/or financial information of the client user, including credit card information, bank information and/or other client user account information.

The device 20, 21, 22, in one embodiment, may host the interface associated with the payment application(s) 32 of the server(s) 28. The web client 16, device application 17, and/or programmatic client 18 may be associated with the financial service provider (FSP). In another embodiment, the web client 16, device application 17, and/or programmatic client 18 may be associated with the third party application 38.

The payment application(s) and/or the financial service provider, in various embodiments, may have an infrastructure to pay a plurality of vendors for a plurality of transactions each day. The payment application(s) and/or the financial service provider may operate independent of the third party. The payment application(s) and/or the financial service provider may be related to the third party, in other embodiments.

The payment applications 32 may be implemented as a standalone software program, which does not necessarily have networking capabilities. For example, the device may be directly connected to the payment application(s) 32, without using the network 14.

The payment application(s) and/or the financial service provider, in various embodiments, may have access to the database 36 having the personal user account information through the database server(s) 34. The user account information may include payment information associated with the client user and an address destination of the client user, for example. The web client 16, device application 17, and/or programmatic client 18 may operate a program supported by the one or more database server(s) 34. The database server(s) 34 may support one or more account information links on a user interface of the network-based device using the web client 16. By accessing the database server(s) 34, the client user may add, amend or delete account information of the client user, among other information. In one implementation, the client user may select a default shipment address and a default payment method in the payment application(s) discussed herein. Depending on whether goods are purchased, a service is requested, a donation is made, or a promotion is selected, a default shipment address, e.g. electronic mail address or a residential address, a business addresses, or a P.O. Box, may be selected by the client user in the payment application(s). One of the default payment methods may include direct transfers from system account balances, internal credit, a gift certificate, a bank account, a debit card, buyer credit, and/or a credit card.

In various implementations, network 14 may include a mobile telephone network, a wireless wide area network (WWAN), a wired telephone network, a wireless local area network (wireless LAN or WLAN), a wireless Metropolitan Area Network (MAN), and/or a wireless personal area network (PAN) (e.g., a Bluetooth® network). Other network-based technologies that may be adapted to connect include PON, VSAT satellite, Micro-impulse Radar, Radio Frequency identification (RFID), Ultra-Wide Band, and/or Infrared. In other various implementations, the network-based device may connect to the web using mobile internet exchange, e.g. Wireless Application Protocol (WAP) and/or Hypertext Transport Protocol (HTTP).

The network 14, in one embodiment, may allow the network-based device 20, 21, 22 to communicate with the third party, e.g. a vendor or a charity, and/or to communicate with the payment application(s) and/or the financial service provider, among others having the capability to communicate through any various means. The network may allow the registration application to communicate with the network-based device 20, 21, 22 and a third-party database 39 for the purpose of establishing a financial transaction account to be stored in the database(s) 36. The network may allow the verification application to communicate with the network-device 20, 21, 22 and the third-party vendor application for the purposes of verifying user access and permission to make a financial transaction and may allow the payment application(s) to communicate with the third-part vendor application and network-based device 20, 21, 22 to process a payment in accordance to instructions from a user to purchase goods or services or make a donation via the third-party vendor's application, for example a website.

As shown in FIG. 1, the third party application 38 may include programmatic access to the network-based system 12 via the programmatic interface provided by the API server 24. In various implementations, the third party application 38 may, utilizing information shared with the network-based system 12, support one or more features or functions on any virtual or physical medium, such as a website, billboard, or magazine, hosted by the third party. The third party website may, for example, provide one or more promotional, marketplace or payment functions that are supported by the relevant applications of the network-based system 12.

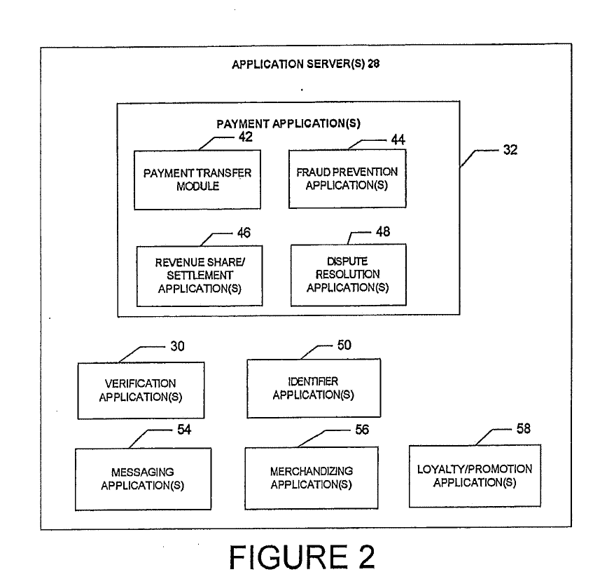

FIG. 2 shows one embodiment of a block diagram of application server(s) that are part of the network-based system 12. In one implementation, registration application(s) 33, payment application(s) 32, verification application(s) 30, identifier application(s) 50, messaging application(s) 54, merchandizing application(s) 56, and/or loyalty/promotion application(s) 58 may be hosted by application server(s) 28 of network system 12.

The registration application(s), in one embodiment, may include an input module, information extraction module, verification module and a registration module. The input module may prompt a user to input information, for example numeric information. The input module may detect information identifying the client device from a header. The information extraction module may connect with a third-party database and may extract additional identifying information related to the user. The verification module may prompt a user to acknowledge that the extracted information is correct. A registration module may send the client device identifying information and user identifying information to a system database to thereby establish an account from which a user may initiate financial transactions via a network.

The payment application(s) 32, in one embodiment, may include a payment transfer module 42, fraud prevention application(s) 44, revenue share/settlement application(s) 46, and/or dispute resolution application(s) 48. The payment transfer module 42 may, in response to the server(s) receiving identifier 166, transfer a payment from the user to the third party via the payment application(s) and/or a financial service provider. The payment may be automatically transferred, as discussed herein. The identifier application(s) 50 may generate the identifier 166 based on selected criteria (e.g. the source or the third party associated with the offer), the type of offer (service, product, promotion, donation opportunity) and/or the placement of the identifier (television ad, magazine ad, and/or client user device).

The identifier application(s) 50, in one embodiment, may be associated with an identifier prompt, such as a prompt link on the network-based device. For example, the prompt link may be a web link and the client user may “click through” the hypertext link on the network-based device to be presented with a webpage interface supported by the application(s) 32. In various implementations, the prompt link may additionally or alternatively use WAP, SMS/MMS, IVR, and/or J2ME, as described herein. The link may allow the client user to submit the identifier to authorize a payment to the third party (e.g. as part of a product request).

The third party application(s) 38, in one embodiment, may keep track of success levels for respective marketing and advertisement campaigns by monitoring identifiers associated with each point of sale. In one implementation, the identifier application(s) 50 may receive identifier 166 upon submission thereof through the device by the client user and may forward the appropriate data to the third party application(s) 38. In another implementation, the identifier application(s) 50 or another application server may track success levels of campaigns and provide this information to the third party.

The application server(s) 28, in one embodiment, may include messaging applications 54. The messaging applications 54 are responsible for the generation and delivery of messages to client users and third parties of the network system 12. Such messages advise client users regarding the status of products (e.g., providing “out of stock” notices to client users). Third parties may be notified of a product order, payment confirmation and/or shipment information. The messaging application(s) 54 may use SMS, IVR, email, or any other appropriate messaging application.

In various embodiments, the network-based system 12, or one or more parties that transact via the system 12, may operate merchandising programs that are supported by one or more merchandising applications 56. The merchandising applications 56 support various merchandising functions that are made available to third parties to enable sellers to increase sales via the system 12. The merchandising applications 56 also operate the various merchandising features that may be invoked by third parties, and may monitor and track the success of merchandising strategies employed by the third parties. For example, merchandising application(s) 56 may monitor efficacy of particular campaigns (e.g., merchandising campaigns) using associated identifiers that may be used in the ordering process, as described herein.

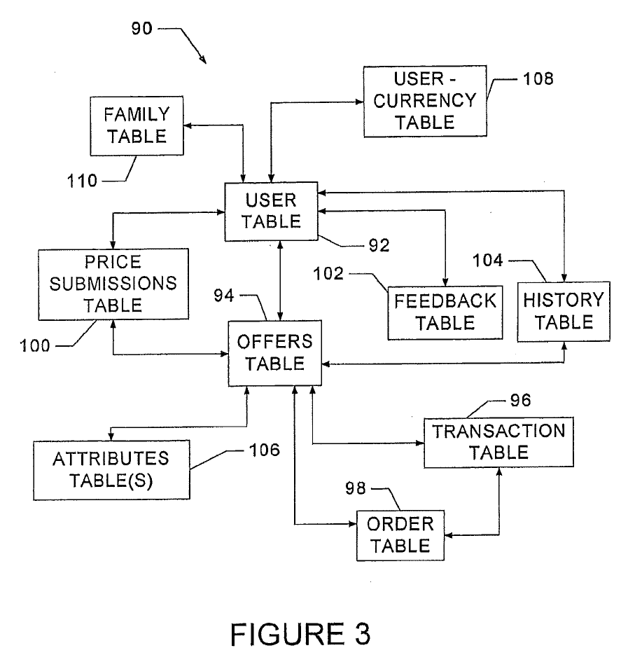

FIG. 3 shows one embodiment of a high-level entity-relationship diagram having various tables 90 that may be maintained within one or more databases 36. The tables 90 may be utilized by and support the application(s) of the application server(s).

The tables 90, in various embodiments, may include a user table 92. The payment application(s) and/or the financial service provider may access the user table and/or may utilize the user table through the database server(s) 34. The user table 92 may comprise a record for each registered user of the network-based system 12, and may include user identification information, address information (including default address), financial instrument information (including default payment method, currency information), and other information (e.g. wireless carrier) pertaining to each such registered user. It should be appreciated that a user may operate as a seller, a buyer, or both, within the network system 12. In one implementation, a buyer may be a client user that has seen an identifier associated with an offer in a magazine advertisement and submits the identifier through the network-based device.

User table entries, in one embodiment, may be provided from the registration application, as described above. In another embodiment, the tables 90 may include purchase request records. The purchase request records may have been established as described above. The purchase request records may be linked to a particular user or may be linked to a prospective user.

The tables 90, in various embodiments, may include an offers table 94 in which are maintained offer records for products, donations, promotions, and services that are or have been, available to be transacted via the system 12. Each offer record may include offer information, price, timing of offering, and other offer related information. Each offer record within offers table 94 may be linked to one or more user records within the user table 92, so as to associate a seller (e.g., the third party) and one or more actual or potential buyers (e.g. a client user) with each offer record. In various implementations, the offers table 94 may be external to system 12, maintained by one or more third party servers, and accessed by one or more application server(s) 28 through one or more interfaces 24, 25, 26, 27.

The tables 90, in one embodiment, may include a transaction table 96 having a record for each transaction (e.g., each purchase transaction) associated with products for which records exist within offers table 94. The transaction table may include information such as buyer, seller, offer, price paid, transaction mechanics, and/or other transaction-related information. In various embodiments, tables 90 may include an order table 98 that may be populated with order records, wherein each order record may be associated with an order. Ione aspect, each order may be in reference to one or more transactions for which records exist within the transactions table 96.

The tables 90, in one embodiment, may include a price submissions table 100 having price submission records therein that relate to one or more price submissions received at the network-based system 12. In one aspect, the price submission table may include bids received in connection with an offer. In various implementations, the price submission received may be associated with an identifier supported by one or more identifier application(s) 50, a request supported by one or more request application(s) 52, an auction-format offer supported by one or more auction application(s) and/or a fixed-price offer supported by one or more fixed-price application(s).

The tables 90, in one embodiment, may include a feedback table 102. In various implementations, the feedback table 102 is utilized by one or more reputation applications to construct and maintain reputation information concerning various types of users, including client users and third parties.

The tables 90, in one embodiment, may include a history table 104. In various implementations, the history table 104 maintains a history of transactions to which a user has been a party.

The tables 90, in one embodiment, may include one or more attributes tables 106 that are adapted to record attribute information pertaining to products for which records exist within the offers table 94. In one example of such an attribute, the attributes tables 106 may indicate a currency attribute associated with a particular product. The currency attribute may identify the currency of a price for the relevant product as specified by a seller. A family table 110 and user-currency table 108 may be used to support related products and multiple currencies in transactions.

In one embodiment, a financial transaction is initiated by creating a prospective transaction record for an intended financial transaction that may be completed at a later time by establishing a financial transaction services account and associated that account with the prospective transaction to complete the transaction or by associating the transaction with a pre-established financial transaction services account. The network-based device is associated with a user and may be a handheld mobile device, for example a cell-phone, and may have a small or non-fully functional keyboard or entry buttons and may have a browser with limited functionality.

As described in reference to FIGS. 1-3, the client user may use the device to initiate a financial transaction. In one embodiment, the user selects a financial transaction on a third-party vendor's application accessed via a network. The user may select the option of making the financial transaction using the financial transaction service provider's application by selecting a link or button on the third-party's website. The financial transaction service provider's system may provide the user with a screen or menu asking for the user to enter a numeric identifier related to the user. For example, the user may input a telephone number. Entering a numeric identifier may be more convenient for the user of the device, for example where the device is a mobile or handheld device with a limited-size entry pad or less than fully functional browser.

In one embodiment, the system may compare the numeric identifier with a pre-existing database of numeric identifiers wherein the numeric identifiers are mapped to additional personal information uniquely related to the user. For example, if the numeric identifier is a telephone number, the system may access a database, for example a third-party database of telephone numbers. The additional personal information may include, for example, a name and/or physical or mailing address. If the telephone number exists in the database, the system may retrieve the additional personal identifying information from the database and present the information to the user. The user may be given the option of acknowledging that the information does, in fact, relate to that user. If the information does relate to the user, the system may create a new account entry with information mapping the device identifying information with the user's identifying information, for example mapping the telephone number to the user's name and address.

In one embodiment, the system may prompt the user to provide information related to a source of funds or credits and/or a method of payment, for example a credit card number of bank account information. Responsive to the prompt, the user may enter appropriate information, for example numerical information, related to the card or account, for example a credit card number and/or a bank account number. The system may then associate the source of funds or credit with the unique device identifier and user identifier. The user may then conduct a financial transaction by requesting to “pay” for an item or service on a third-party webpage.

In one embodiment, the user may initiate and create an online financial transaction account by entering only numerical information including a device identifying set of numbers (e.g. telephone number) and a source of funds identifier (credit card and/or bank account number). The user identifying information that includes alphabetic characters may be extracted from a pre-existing database that maps the device identifier to the user.

In another embodiment, a user may wish to initiate a financial transaction, for example, by initiating a text-to-buy transaction without taking the time to complete all of the purchasing credentials at that time. The user may observe a text-to-buy offer over some medium, for example in an advertisement heard or seen on any audible or visual electronic medium, reading an advertisement in a print medium, observing a physical billboard, sign, flier or other advertisement located in the third-party vendor's store or anywhere else. The offer may include an offer identifier or ID and a telephone to text the offer identifier to using, for example, a text messaging service. In one implementation, the text message may be received by an application provided, for example, by a financial transaction services provider. The text message may be associated with a unique identifier for the device from which the text-to-buy transaction is initiated, for example the telephone number, and a prospective financial transaction record may be created in a database, mapping the device to the offer and the third-party vendor. Receipt of the message may cause a text message to be automatically generated and sent to the device. The automatically generated message may include information on how to complete the financial transaction. The prospective financial transaction may be completed, for example, by accessing an application. The application may be accessed, for example, over a network, for example the internet. The application may be accessed by the same device, provided that the device is also a network-based device, or any other network-based device. When the application is accessed, the user may be presented with a prompt to access the prospective financial transaction record. The user may then be offered the opportunity to establish a financial transaction services account and then to associate the prospective transaction with the account to make the payment, or to associate the prospective transaction with a pre-established account to complete the transaction. Having the ability to initiate transactions without completing the transaction at that time may be convenient for some users who may see an offer that they want to take advantage of at a time during which they it would not be convenient to take the time to provide the purchasing credentials. It may also make it possible for a user to create a number of prospective financial transaction records—and then to complete all of the transactions at one time when it is more convenient. In one implementation, the prospective financial transaction records may be kept for a pre-determined period of time, for example twelve hours or twenty-four hours. In various other embodiments, a user may wish to initiate a financial transaction by specifying a mobile checkout or by providing a contactless payment (e.g., near-field communications, such as RFID) without departing from the scope of the present disclosure.

In one embodiment, the user may not yet have associated an online financial transaction services account to a particular client device or may find it more convenient to complete the transaction later. However, the user may wish to perform a text-to-buy transaction. The user may text a message to initiate the transaction and may complete the transaction by providing or entering sufficient purchasing credentials (e.g. name and method of payment and sufficient information to effect payment). The user may have access to the transaction for a limited period of time, for example 12 to 24 hours, although the time may be longer or shorter. During this period of time, the user has access to the transaction and may complete the credentials a later time, for example either online or on a mobile phone. Once the credentials are complete, the user may receive the purchased item. In one aspect, the credentials may be completed by creating a new account for online financial transaction services as described above, or by using a pre-existing account already associated with the device or a pre-existing account that may be accessed by a different device.

A seller, for example, may advertise a text-to-buy service with a number or phrase to text-message to a particular phone number. A user may initiate the transaction by texting the appropriate information to the appropriate number. The user may therefore initiate an impulse purchase, without having to take the additional time to complete the purchase or arrange for payment. This may be convenient for the user and may generate more sales for the vendor.

Responsive to the text-to-buy message generated by the purchaser, the vendor may send a text message to the device which may be accessed by the user at a later time. The message may include a link to the vendor's website for arranging payment. The payment site may include an option of using a financial transaction service for arranging for payment to the third-party vendor. If the user has previously created an account, either associated with the device or accessible from another device, the user may complete the transaction using that account. If the user has not previously associated the device with an account, the user may create an account and initiate the appropriate financial transaction as described above.

FIG. 4 shows one embodiment of a method 400 for facilitating and/or initiating a financial transaction with a network-based mobile device. In various implementations, the method 400 is executed by one or more components of the network-based system 12, as a transaction service provider, in communication with a user having access to at least one of the client devices 20, 21, 22.

As shown in FIG. 4, a transaction request is received (block 410). In one example, the system 12 receives a request for a financial transaction from at least one client device 20, 21, 22. Next, user information is identified (block 414). In one example, the system 12 identifies a numerical identification number from the at least one client device 20, 21, 22, which may be in the form of a mobile identification number including a mobile phone number and/or serial number of the mobile device. It should be appreciated that various other types of numerical identification information may be used including a landline phone number, a partial physical address, such as a street number, postal code and/or zip code in some combination thereof.

Next, a determination is made as whether the user has an existing user account (block 418). In one example, the system 12 determines if the user requesting the financial transaction has an existing user account therewith. If yes, then the existing user account is accessed (block 422). If not, then a new user account may be established with the user if desired by the user (block 426). In one implementation, the system 12 may offer the user to open a new user account, and the user may select to open or not open an new user account with the system 12.

Next, verification information is requested (block 430) and received (block 434). In one example, the system 12 may request identification information from the user, such as a PIN number, prior to completing the financial transaction. In various implementations, the PIN number may be stored as part of an existing user account and/or provided when the user creates a new user account with the system 12. Next, once the verification information is received and/or the identity of the user is verified (block 434), the requested financial transaction may be completed (block 438). In one example, the system 12 may complete the financial transaction by communicating with a third party (e.g., a merchant and/or merchant device) via the network 14, which may include transferring payment from a user account associated with the user and/or user device (e.g., at least one of the client devices 20, 21, 22) to an account associated with the third party via the network.

In one implementation, a financial transaction may be initiated by establishing an account with a transaction service provider, such as system 12. A user may create the account without having to enter any non-numeric information. For example, a user may enter a telephone number (e.g., from a network-based mobile device including a mobile phone), numerical portion of a street address or postal code. The registration application may access a third-party database in which non-numeric data is mapped to the entered numeric data. The user may then verify the information and create an account by creating a personal identification number (PIN) and entering bank routing and account information and/or a credit card number. Once the account is created, the user may complete the purchase using the account. This may be convenient for a mobile or handheld network-based device user where the keyboard may be limited and/or the browser may be non-fully functional. A user may conveniently create an account on a handheld or mobile device without entering non-numeric information from the keypad.

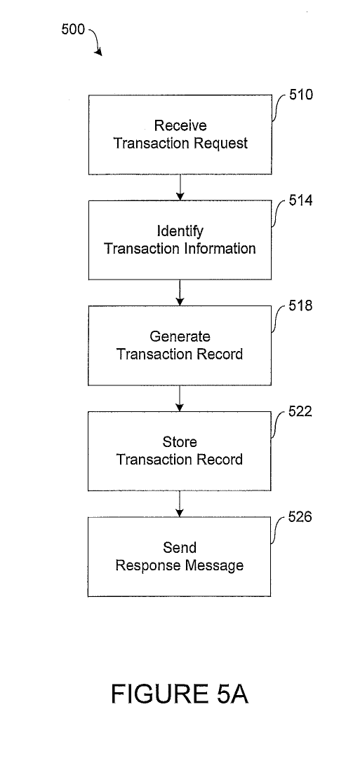

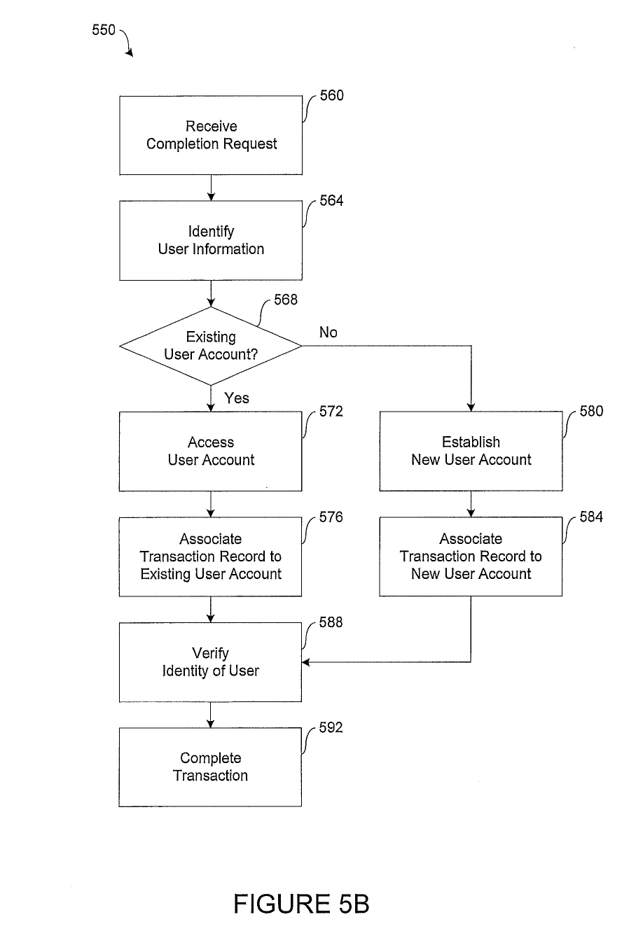

FIG. 5A shows one embodiment of a method 500 for facilitating and/or initiating a financial transaction with a network-based mobile device. In various implementations, the method 500 is executed by one or more components of the network-based system 12, as a transaction service provider, in communication with a user having access to at least one of the client devices 20, 21, 22.

As shown in FIG. 5A, a transaction request is received (block 510). In one example, the system 12 receives a request for a financial transaction from at least one client device 20, 21, 22. Next, transaction information is identified (block 514). In one example, the system 12 identifies a numerical identification number from the at least one client device 20, 21, 22, which may be in the form of a mobile identification number including a mobile phone number and/or serial number of the mobile device.

Next, a transaction record is generated (block 518). In one example, the system 12 generates a transaction record based on information passed with the transaction request, which may include information related to the user (e.g., mobile device number), a merchant (e.g., name, physical address, website address), product identification (e.g., product serial number, barcode, price) and/or various other types of information including the date and time of purchase. Next, the transaction record may be stored (block 522). In one example, the system 12 may store the generated transaction record in a database, such as database 36, for reference. Next, a response message may be sent to the user (block 526). In one example, after generating the transaction record, the system 12 may send a response message to at one of the client devices 20, 21, 22 used by the user to indicate that the transaction record has been generated and stored. The response message may also indicate that the transaction may be completed at another time.

FIG. 5B shows one embodiment of a method 550 for facilitating and/or completing a financial transaction with a network-based mobile device. In various implementations, the method 550 is executed by one or more components of the network-based system 12, as a transaction service provider, in communication with a user having access to at least one of the client devices 20, 21, 22.

As shown in FIG. 5B, a completion request is received (block 560). In one example, the system 12 receives a request to complete a previously requested financial transaction from at least one client device 20, 21, 22. Next, user information is identified (block 564). In one example, the system 12 identifies a numerical identification number from the at least one client device 20, 21, 22, which may be in the form of a mobile identification number including a mobile phone number and/or serial number of the mobile device. This user information may be passed with the completion request.

Next, a determination is made as whether the user has an existing user account (block 568). In one example, the system 12 determines if the user requesting completion of a financial transaction has an existing user account therewith. If yes, then the existing user account is accessed (block 572), and a transaction record of the previously requested financial transaction is associated with the existing user account (block 576). If not, then a new user account may be established with the user if desired by the user (block 580), and the transaction record of the previously requested financial transaction is associated with the new user account (block 584). In one implementation, the system 12 may offer the user to open a new user account, and the user may select to open or not open an new user account with the system 12.

Next, the identity of the user may be verified prior to completing the financial transaction associated with the transaction record (block 588). In one example, the system 12 requests and receives identification and/or verification information from the user via the client device 20, 21, 22. In various implementations, the requested identification information from the user may include a PIN number. As previously described, the PIN number may be stored as part of an existing user account and/or provided when the user creates a new user account with the system 12. Next, once the identity of the user is verified (block 588), the requested financial transaction may be completed (block 592). In one example, as previously described, the system 12 may complete the financial transaction by communicating with a third party (e.g., a merchant and/or merchant device) via the network 14, which may include transferring payment from a user account associated with the user and/or user device (e.g., client device(s) 20, 21, 22) to an account associated with the third party via the network.

In one implementation, a user may initiate a financial transaction by creating a prospective transaction record, for example by initiating a “text-to-buy” transaction. The record may include information identifying a third-party vendor, the transaction to be performed (e.g. goods or service to be purchased and price) and the device from which the prospective financial transaction was initiated. The record may be stored in a database, such as one maintained by a financial transaction services provider. The system may generate and send a response message to the user and/or the device. The message may include information or a link for accessing the potential transaction record and to complete the transaction. The user may complete the transaction from the same device or other network-based device and may complete the transaction by establishing a new financial transaction services account, such as described above, and completing the transaction by associating the prospective transaction with the new account or by associating the transaction with a previously existing account.

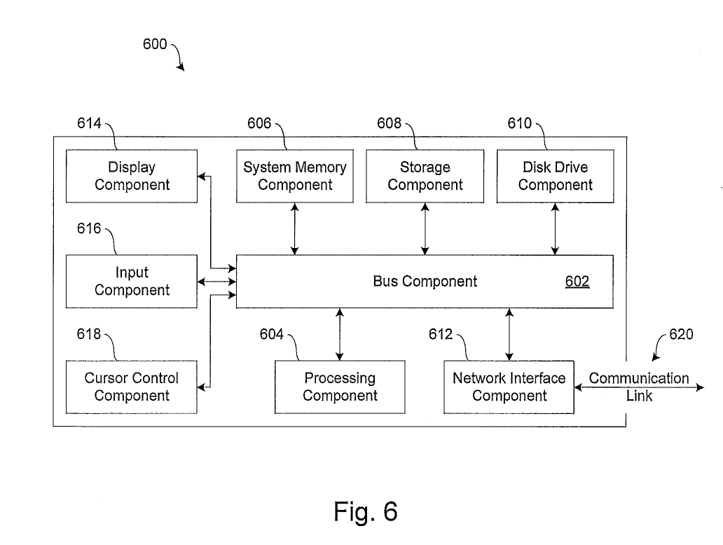

FIG. 6 is a block diagram of a system 600 (e.g., computing and/or processing system) suitable for implementing embodiments of the present disclosure, including the client devices 20, 21, 22, the third party server 40, and the servers 24, 25, 26, 27, 28, 34 of the network-based system 12. In various implementations, the client devices 20, 21, 22 may comprise a personal computing device, such as a mobile phone, cellular phone, a personal computer, laptop, PDA. Thus, it should be appreciated that any of the devices in FIG. 1 may be implemented as system 600 in a manner as follows.

In various embodiments, system 600 includes a bus 602 or other communication mechanism for communicating information, to interconnect subsystems and components, such as processing component 604 (e.g., processor, micro-controller, digital signal processor (DSP), etc.), system memory component 606 (e.g., RAM), static storage component 608 (e.g., ROM), disk drive component 610 (e.g., magnetic or optical), network interface component 612 (e.g., modem or Ethernet card), display component 614 (e.g., CRT or LCD), input component 616 (e.g., keyboard), and cursor control component 618 (e.g., mouse or trackball). In one implementation, disk drive component 610 may comprise a database having one or more disk drive components. It should be appreciated that one or more of the components may be integrated as part of the system 600 or one or more of the components may be peripheral to the system 600 without departing from the scope and functionality of the present disclosure.

In various embodiments, system 600 performs specific operations by processor 604 executing one or more sequences of one or more instructions contained in system memory component 606. Such instructions may be read into system memory component 606 from another computer readable medium, such as static storage component 608 or disk drive component 610. In other embodiments, hard-wired circuitry may be used in place of or in combination with software instructions to implement the invention.

Logic may be encoded in a computer readable medium, which may refer to any medium that participates in providing instructions to processor 604 for execution. Such a medium may take many forms, including but not limited to, non-volatile media, volatile media, and transmission media. In various implementations, non-volatile media includes optical or magnetic disks, such as disk drive component 610, volatile media includes dynamic memory, such as system memory component 606, and transmission media includes coaxial cables, copper wire, and fiber optics, including wires that comprise bus 602. In one example, transmission media may take the form of acoustic or light waves, such as those generated during radio wave and infrared data communications.

Some common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, contactless media (e.g., near-field communications, such as RFID), or any other medium from which a computer is adapted to read.

In various implementations, execution of instruction sequences to practice embodiments of the present disclosure may be performed by system 600. In various other implementations, a plurality of computer systems 600 coupled by communication link 620 (e.g., network 14 of FIG. 1, mobile network, cellular network, satellite network, LAN, WLAN, PTSN, or various other wired or wireless networks) may perform instruction sequences to practice the invention in coordination with one another.

In various embodiments, system 600 may transmit and receive messages, data, information and instructions, including one or more programs (i.e., application code) through communication link 620 and network interface component 612. Received program code may be executed by processor 604 as received and/or stored in disk drive component 610 or some other non-volatile storage component for execution.

Where applicable, various embodiments provided by the present disclosure may be implemented using hardware, software, or combinations of hardware and software. Also, where applicable, the various hardware components and/or software components set forth herein may be combined into composite components comprising software, hardware, and/or both without departing from the spirit of the present disclosure. Where applicable, the various hardware components and/or software components set forth herein may be separated into sub-components comprising software, hardware, or both without departing from the scope of the present disclosure. In addition, where applicable, it is contemplated that software components may be implemented as hardware components and vice-versa.

Software, in accordance with the present disclosure, such as program code and/or data, may be stored on one or more computer readable mediums. It is also contemplated that software identified herein may be implemented using one or more general purpose or specific purpose computers and/or computer systems, networked and/or otherwise. Where applicable, the ordering of various steps described herein may be changed, combined into composite steps, and/or separated into sub-steps to provide features described herein.

The foregoing disclosure is not intended to limit the present invention to the precise forms or particular fields of use disclosed. It is contemplated that various alternate embodiments and/or modifications to the present invention, whether explicitly described or implied herein, are possible in light of the disclosure.

Having thus described embodiments of the invention, persons of ordinary skill in the art will recognize that changes may be made in form and detail without departing from the scope of the invention. Thus, the invention is limited only by the claims.

What is claimed is:

1. A system comprising:
an interface to communicate with a user device via a network;
a first component adapted to receive a first numeric identifier from the user device and associate the first numeric identifier with a user account; and
a second component adapted to process a financial transaction requested by the user device.

2. The system of claim 1, wherein the user device comprises a mobile phone.

3. The system of claim 1, wherein the first numeric identifier comprises a mobile phone number associated with the user device.

4. The system of claim 1, wherein the first component is adapted to receive a second numeric identifier from the user device and compare the second numeric identifier to the first numeric identifier and the user account to verify the identity of the user device prior to processing the requested financial transaction.

5. The system of claim 4, wherein the second numeric identifier comprises a security code including at least a PIN number.

6. The system of claim 1, further comprising a database adapted to store information related with the user account, wherein the first component is adapted to query the database and retrieve the user account associated with the first numeric identifier.

7. The system of claim 1, wherein the first component is adapted to receive a request for the financial transaction from the user device.

8. The system of claim 7, wherein the second component is adapted to process the financial transaction based on information passed with the request.

9. The system of claim 1, wherein the interface is adapted to communicate with a third party via the network.

10. The system of claim 9, wherein the second component is adapted to transfer payment from the user account to an account associated with the third party via the network to complete the requested financial transaction.

11. A method comprising:
communicating with a user device via a network;
receiving a first numeric identifier from the user device;
associating the first numeric identifier with a user account; and
processing a financial transaction requested by the user device.

12. The method of claim 11, wherein the user device comprises a mobile phone.

13. The method of claim 11, wherein the first numeric identifier comprises a mobile phone number associated with the user device.

14. The method of claim 11, further comprising:
receiving a second numeric identifier from the user device; and
comparing the second numeric identifier to the first numeric identifier and the user account to verify the identity of the user device prior to processing the requested financial transaction.

15. The method of claim 14, wherein the second numeric identifier comprises a security code including at least a PIN number.

16. The method of claim 11, further comprising:
storing information related with the user account in a database; and
querying the database to retrieve the user account associated with the first numeric identifier.

17. The method of claim 11, further comprising receiving a request for the financial transaction from the user device.

18. The method of claim 17, wherein processing the requested financial transaction is based on information passed with the request.

19. The method of claim 11, further comprising communicating with a third party via the network.

20. The method of claim 19, further comprising completing the requested financial transaction by transferring payment from the user account to an account associated with the third party via the network.

21. A system comprising:
means for communicating with a user device via a network;
means for receiving a first numeric identifier from the user device;
means for associating the first numeric identifier with a user account; and
means for processing a financial transaction requested by the user device.

22. The system of claim 21, wherein the user device comprises a mobile phone, and wherein the first numeric identifier comprises a mobile phone number associated with the user device.

23. The system of claim 21, further comprising:
means for receiving a second numeric identifier from the user device; and
means for comparing the second numeric identifier to the first numeric identifier and the user account to verify the identity of the user device prior to processing the requested financial transaction,
wherein the second numeric identifier comprises a security code including at least a PIN number.

24. The system of claim 21, further comprising:
means for storing information related with the user account in a database; and
means for querying the database to retrieve the user account associated with the first numeric identifier.

25. The system of claim 21, further comprising:
means for communicating with a third party via the network; and
means for completing the requested financial transaction by transferring payment from the user account to an account associated with the third party via the network.
